(19) United States
(12) Patent Application Publication
(10) Pub. No.: US 2008/0155511 A1
(43) Pub. Date: Jun. 26, 2008

(54) System and method for detecting events in computer code using interval values simulation

(75) Inventor: Jason A. Cohen, Austin, TX (US)

Correspondence Address: HULSEY IP INTELLECTUAL PROPERTY LAWYERS, P.C., 919 Congress Avenue, Suite 919, AUSTIN, TX, 78701, US

(73) Assignee: Smart Bear, Inc.

(21) Appl. No.: 11/642,066

(22) Filed: Dec. 20, 2006

(51) Int. Cl. G06F 9/44

(52) U.S. Cl. 717/131

(57) ABSTRACT

A method, system, and program for static analysis of source code by simulation of source code execution. The invention performs a simulation of subroutine source code execution while tracking the associated data values in the specific data formation of intervals during the simulation. When the data flow reaches a predetermined event, the data flow can bifurcate to simulate multiple data flow paths while also identifying these as points of interest. These points of interest are recorded during the simulation and relayed to a code analyst as a point of interest along with the results of the simulation.

### TECHNICAL FIELD OF THE INVENTION

The invention relates to static source code analysis by way of program simulation. More specifically, the invention deals with the results of a simulation of subroutines in a program through the testing of value ranges. The invention also examines the interrelationship between the parent program and the subroutines.

### BACKGROUND OF THE INVENTION

Computer programmers frequently have to remove issues from programs they write before they are completed. These issues can produce a variety of effects, from making the program ‘crash’ to allowing unauthorized access to the program. In response to this need, there are source code analysis tools that can detect where these programming issues occur.

Prior source code analysis tools used to aid programmers had various problems that lead to undesired results. One example comes from source code analysis tools returning erroneous results, or ‘false-positives’. One reason for these false positives is due to the use of subroutines to perform repetitive actions in a program. These source code analysis tools could check the parent program or the subroutine separately, but could not examine both the parent and the subroutine simultaneously. Due to these components being examined individually, there was no way for the tool to realize that when the entire program was executed the error did not exist.

Different source code analysis tools had the opposite issue. The source code analysis tools would examine the code and only report instances where there was a very high probability that an event would occur. The problem with these source code analysis tools came from the omission of many possibilities that the source code analysis tools were not sensitive enough to detect.

Another issue with source code analysis tools is they alert the user that an event has occurred, but not necessarily why the event occurred. Learning why an event occurs is critical for an effective program examination. Another issue is once certain types of events are detected, then the program automatically terminates, as does the source code analysis tool. There could be more detectable events in the source code, but they remain undetected due to their not being examined since the program terminated.

Most source code analysis tools make mathematical ‘maps’ to analyze the source code. This ‘map’ shows all the various paths the code can take while being executed. This is similar to the use of proof engines. The problem is the proofs become complex very quickly in these situations. In many cases subroutines are bigger than a page with numbers of loops and local variables. When these proofs are created from the source code, they become extremely complex. This is due to various functions in a subroutine, such as loops, conditional jumps, or parts of the code depending on preceding events in the code. Each of these paths needs to be considered in the proof engine, adding to the complexity. With increased complexity, the tool becomes unwieldy for diagnostic functions.

Another issue that source code analysis tools cannot account for are methods for avoiding events such as errors. One type of method used to prevent errors are referred to as ‘cleanser’ subroutines. ‘Cleansers’ assign the variable have a value of zero (0) to avoid various programming related issues when a variable has no value assigned to it. When a source code analysis tool looks at a subroutine, it does not look to any other subroutines called, including ‘cleansers’. While an executed program might not have an error, a source code analysis tool will not see that and report a possible error. There could also be cases where the subroutine returning an error might not be fatal to the entire program due to another condition in the code, but the source code analysis tool will not know to look for that. An otherwise harmless error could also prevent further analysis of the program by the source code analysis tool as it perceives the program might not be operable beyond that point.

A need exists for a method, system, and program for static analysis of source code by simulation of source code execution. The invention performs a simulation of subroutine source code execution while tracking the associated data values in the specific data formation of intervals during the simulation. When the data flow reaches a predetermined event, the data flow can bifurcate to simulate multiple data flow paths while also identifying these as points of interest. These points of interest are recorded during the simulation and relayed to a code analyst as a point of interest along with the results of the simulation.

### SUMMARY OF THE INVENTION

The method, system, and program illustrated and described herein have several features, no single one of which is solely responsible for its desirable attributes. Without limiting the scope as expressed by the description that follows, its more prominent features will now be discussed briefly. After considering this discussion, and particularly after reading the section entitled “DETAILED DESCRIPTION OF THE ILLUSTRATIVE EMBODIMENTS” one will understand how the features of the invention provide for the analysis of source code.

The invention is a method, system, and program for static analysis of source code by simulation of source code execution. The invention performs a simulation of subroutine source code execution while tracking the associated data values in the specific data formation of intervals during the simulation. When the data flow reaches a predetermined event, the data flow can bifurcate to simulate multiple data flow paths while also identifying these as points of interest. These points of interest are recorded during the simulation and relayed to a code analyst as a point of interest along with the results of the simulation.

The invention can be used in most computer languages for various forms of event detection, including most error types, weakness in security that make a system vulnerable to external interference, and array balance checking. The first aspect of this invention is it utilizes a special data type called an interval. Intervals are mathematical ranges used for inputs in the simulation. Intervals can be used for any data type. The value of the ranges depends on the original data type. An integer can be converted into a range before the simulation is performed. These ranges can reach from negative infinity to infinity. Secondly, the invention addresses the issue of looping which can greatly reduces the amount of processing time needed to complete the simulation. Most programs have a series of conditional statements that determine which set of instructions are followed for the remainder of the program. The simulator makes a copy of the program simulation up to that point and executes the first choice in the program. It later returns on a subsequent loop and completes the other choice. Another instance that could make a simulation return to an earlier point comes from loop generated not by the simulator but from the program itself. When this occurs, the instructions are repeated again as directed by the source code.

With both loops and conditional statements that need to be repeated, there could be a potentially infinite number of times the simulation is repeated if the values used were integers. This invention prevents redundant loops from repeating unnecessarily.

A way to prevent the possibility of infinite loops is to end the loop by seeing if the loop has already been accomplished. In this case, the use of a value ranges instead of integers are helpful. When a loop occurs, the simulator will see if the ranges being simulated have already been used. If so, there is no need to repeat the loop.

The preemption of infinite loops can be accomplished in some cases via loop induction. In loop induction, the initial conditions of the first loop are known. When a loop is executed after the first time, the simulator wants to combine all the iterations into one execution. This is possible as most loops are exactly the same. The source code makes might make no material distinction between loop two and loop two thousand in the code. The second time a loop is executed, the range could be from one to infinity. When the next loop is executed, the range might have increased an increment so it is now two to infinity. Since that range has already been analyzed, the rest of the loop can be ignored as it has already been simulated.

The third aspect of the invention involves the interprocedural nature of the source code analysis. Prior to this invention, subroutines were examined individually without benefit of the context of the larger program. When values are processed through these subroutines, the return values can be stored in cache memory to make future simulation of the subroutine unnecessary if the subroutine is recalled. The return values need to be saved as a cleanser program could be used to remove their true vales during the course of the program simulation. This process allows value retention to afford intelligent decisions in source code analysis while minimizing processing resources.

When simulation detects an event of interest, the simulator logs that an event of interest has occurred, such as retuning a value to the caller, or invoking an object. Notification by the simulation alerts the user might need the information for a real code analysis.

### BRIEF DESCRIPTION OF DRAWINGS

The present invention will be described with particular embodiments thereof, and references will be made to the drawings in which:

FIG. 1 is a subroutine analysis algorithm, involving the use of input values as ranges and a loop structure to account for multiple code paths, and is structured to account for both parent routines and subroutines.

FIG. 2 is a return value cache load algorithm, showing output results of various previously generated input ranges.

FIG. 3 is a subroutine simulation algorithm that takes input range values and simulates the source code to determine the associated output range values.

FIG. 4 is a local variable merge algorithm that accomplishes loop induction to reduce the number of times a loop needs to be repeated if the variable values are the same.

FIG. 5 is an argument list generation algorithm, used to determine what range values are important in the simulation.

FIG. 6 is a return value cache generation algorithm, storing the output values of previously generated input ranges.

FIG. 7 illustrates the subroutine simulation analysis method when used to look for a null pointer exception when a subroutine is invoked.

FIG. 8 illustrates the subroutine simulation analysis method when used to look for a null pointer exception when a subroutine event point is reached.

FIG. 9 illustrates the subroutine simulation analysis method when used to look for a null pointer exception when an object is referenced.

### DETAILED DESCRIPTION OF PREFERRED EMBODIMENTS

The present invention is a method, system, and program for static analysis of source code by simulation of source code execution. The invention performs a simulation of subroutine source code execution while tracking the associated data values in the specific data formation of intervals during the simulation. When the data flow reaches a predetermined event, the data flow can bifurcate to simulate multiple data flow paths while also identifying these as points of interest. These points of interest are recorded during the simulation and relayed to a code analyst as a point of interest along with the results of the simulation.

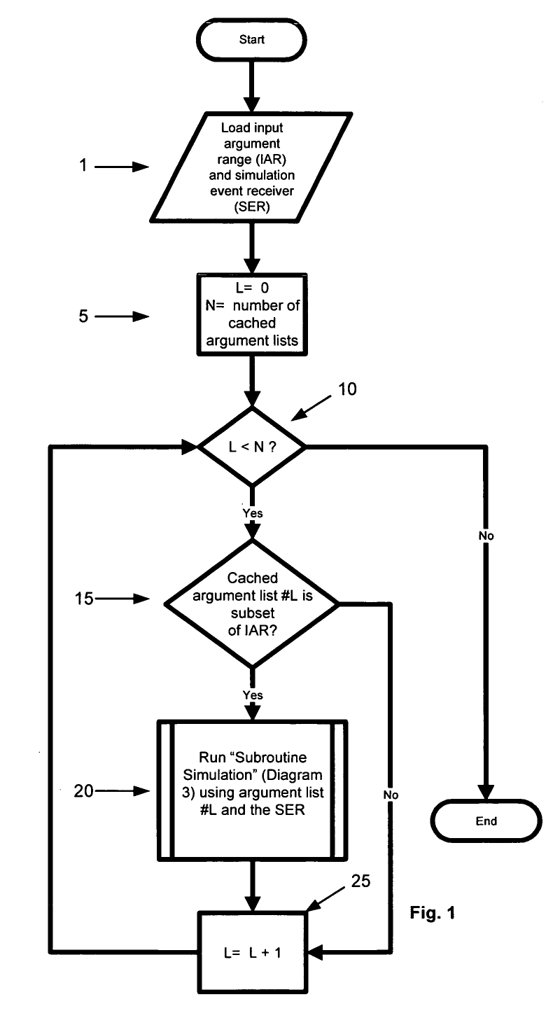

FIG. 1 illustrates the general subroutine analysis algorithm. The first step is to load the input argument range (IAR) and a simulation event receiver (SER) 1. The IAR is a specific argument list generated by the user. It is unlikely the simulator will generate an argument list that exactly fits this input. The invention will seek cached entries that together would satisfy the IAR and union them together. The SER is the object that records relevant points as indicated by the simulator.

The initial variables are reset. The loop counter L is set to zero (0) 5. The value of N is set to the number of cached argument lists. This number of cached argument lists is computed before the simulation begins the analysis. SER contains an empty interval that will be filled during the course of subroutine simulator algorithm execution. When the loop begins, the algorithm will look to see if the loop counter is less than the number of arguments (N) 10. If the loop counter is equal to or more than the number of loop arguments, then the results listed in the SER are the returned results 10. If the loop counter is still less than the number of arguments, the loop continues 10.

The subroutine analysis algorithm looks to see if the argument list entry in the cache that corresponds with the current loop counter is a subset of the input argument range 15. If the value is not in the range, the loop counter increments and the loop begins again asking if the loop counter is still less than the total number of arguments 25. If the cached argument that corresponds with the loop counter is a subset of the IAR 15, the argument is sent to be processed though the subroutine simulation algorithm, and the resulting interval is then unioned with the interval value previously in the SER 20. L then increments and the loop again asks if the loop counter is less than the total number of arguments 25. This continues until all arguments are examined 10.

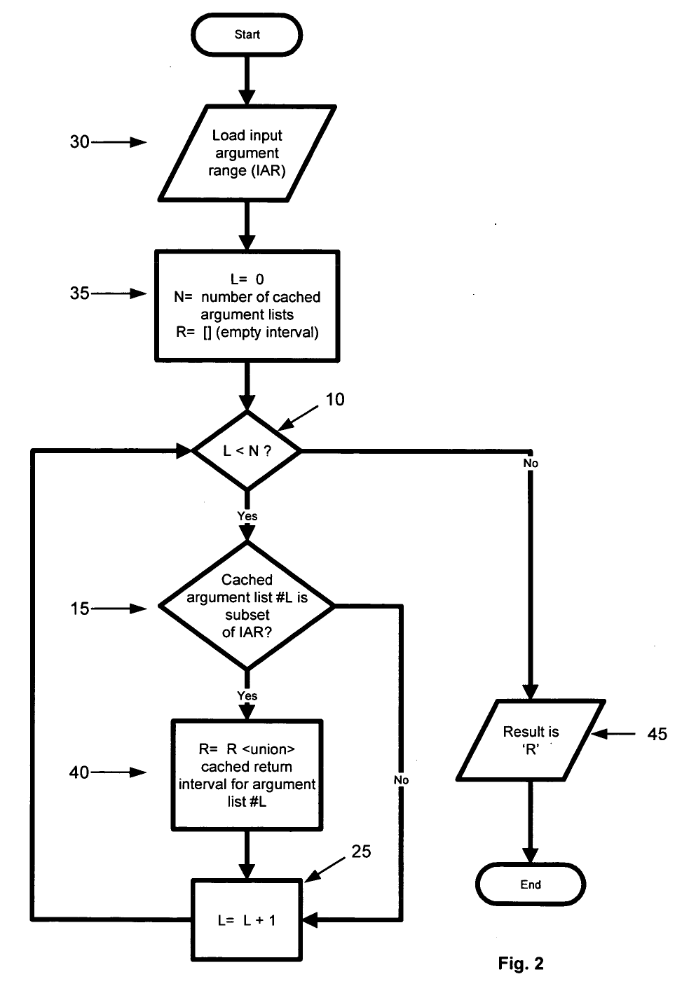

FIG. 2 illustrates how to load the return value from the cache. The first step is to load the input argument range (IAR) 30. This is a specific argument list input by the user. It is unlikely that there is a precached list that exactly fits this input. The system will seek cached entries that together would satisfy the IAR and then union them together.

The initial variables are reset. The loop counter L is set to zero (0) 35. The value of N is set to the number of cached argument lists 35. This number of cached argument lists is computed before the simulation begins the analysis. R is an empty interval that will be filled during the course of subroutine simulator algorithm execution 35. When the loop begins, the algorithm will look to see if the loop counter is less than the number of arguments (N) 10. If the loop counter is equal to or more than the number of loop arguments, then the results listed in the R interval are the retuned results 45. If the loop counter is still less than the number of arguments, the loop continues 10.

The subroutine simulation algorithm looks to see if the argument list entry in the cache that corresponds with the current loop counter is a subset of the input argument range 15. If the value is not in the range, the loop counter increments and the loop begins again asking if the loop counter is still less than the total number of arguments 25. If the cached argument that corresponds with the loop counter is a subset of the IAR 15, then the interval is then unioned into the interval of R along with whatever value might have previously been in interval R 40. L then increments and the loop again asks if the loop counter is less than the total number of arguments. This continues until all arguments are examined 25.

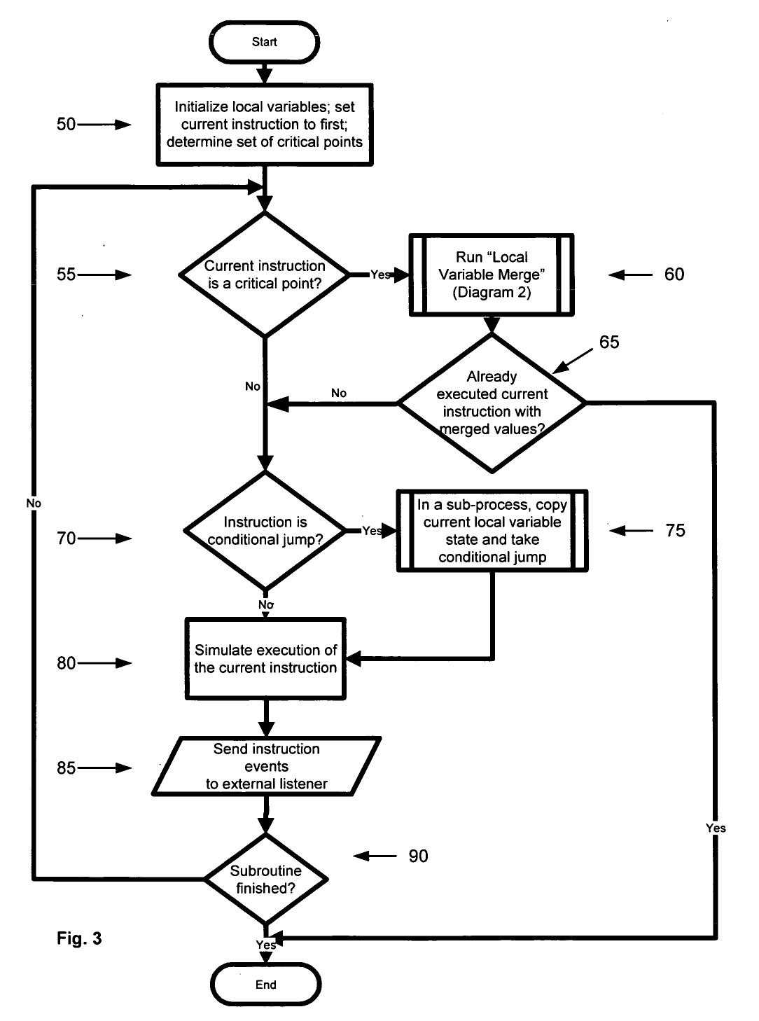

FIG. 3 illustrates the subroutine simulation algorithm process for a single subroutine. The subroutine simulation algorithm is accessed from several different algorithms in this invention. The local variables in the subroutine are initialized before the subroutine begins to process the information 50. The algorithm then establishes if this is the first time the subroutine is being used for this incident. Critical points are identified as the places in the subroutine where two streams of code execution can be brought together in the event an identical execution of the subroutine has previously occurred, eliminating the need to repeat an execution 55. In addition to critical points, conditional jumps that occur in this subroutine are also noted 70. Once initial information is gathered, the loop in the subroutine simulation analysis can begin.

As the loop begins, the first question is whether an instruction is a critical point, as was identified before the loop began 55. If the instruction is a critical point, there must be a determination as to whether this instruction has been executed previously with the same input values. This situation directs the subroutine to a local variable merge subroutine to determine how the variables are to be treated by means of a process called loop induction 60. Once the local variable merge has returned the values, the subroutine asks whether the set of executed instructions has already used those merged values 65. If they have been used, the subroutine is complete. If the merged values have not been used, then the subroutine acts as if the instruction was not a critical point for this iteration of the subroutine 65.

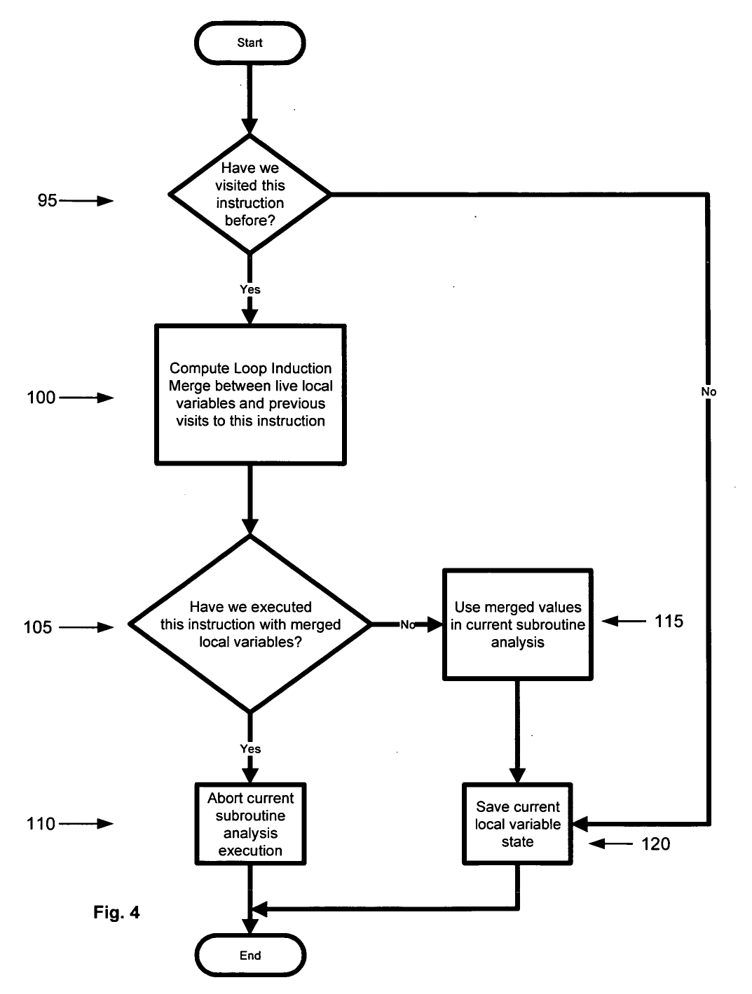

After critical point issues have been resolved, the next part of the subroutine simulation involves possible conditional jumps 70. Conditional jumps allow for the possibility of different choices. If there is no conditional jump, then the instruction execution is simulated 80. If there is a conditional jump, the local variables are copied to a sub-process for later processing, which will execute the subroutine simulation of the conditional jump 75. The critical point analysis and the local variable merge algorithm per FIG. 4 ensure the simulation will not repeat this process indefinitely.

Once simulation of the current instruction ends, the subroutine sends the information gathered to the SER 85. If there are no more instructions in the subroutine, then the process is complete 90. If it is not complete, the next instruction is determined and control returns to the beginning of the algorithm, but the variable values are not reinitialized 90.

FIG. 4 illustrates the local variable merge algorithm, which performs loop induction. This is accessed from the subroutine simulation algorithm when a critical point has been found. The first question is whether the instruction has been visited before 95. This is determined by a higher controller routine that records if an instruction has been previously accessed. If the instruction has not been accessed before, then the variables are saved and the algorithm exits back to the subroutine simulation 120.

If the instruction has been visited before, a compute loop induction merge occurs between the live local variables that were used to enter the local variable merge algorithm and those stored from previous visits to the local variable merge algorithm 100. The question becomes what are the differences between the variables in this interaction versus the result of the latest local variable merge algorithm 105. If all the variables but the loop counter are the same, then the data flow is the same and there is nothing to merge 110. The subroutine is aborted as the repeating of execution of the same instruction could lead to an infinite loop. If the variables are different, then that is a different data flow. Since this data has not been analyzed before, there is a need to see what the effect of these variables are in this process. For integers, the value upon merging can become the range from negative infinity to infinity.

Once the variables have been merged, the issue becomes whether local instructions have used these merged local variables. If local instructions have not used these values, the merged values are used in the subroutine analysis 115. The variables are saved and the algorithm exits back to the subroutine simulation 120.

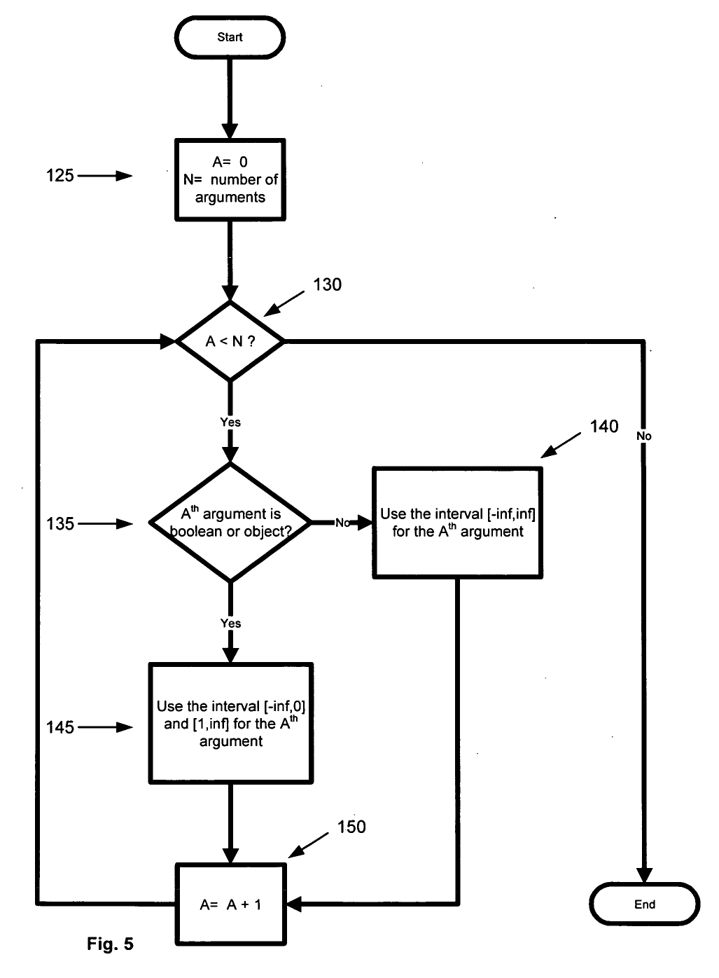

FIG. 5 shows the process of generating the argument list to be used in the simulation. The number of potential arguments in the list is approximately the number of arguments in the program raised to the second power. This number of arguments is needed to have enough paths generated and get enough information that when subroutines were called that the process would create correct answers and not false positives. If a tailored list was not created for those processes, the process would be more cumbersome. If each value was taken individually, then the process would never finish. If the range used was negative infinity to infinity, that would not be helpful either. By using ranges based on critical points, the list is good enough to provide useful data, but not so much as to be unwieldy.

Before the process begins, values are initialized. A acts as a loop counter to identity the number of the arguments 125. N is the number of arguments for the subroutine being cached 125. When the loop is entered, the subroutine looks to see if the loop counter is less than the total number of arguments 130. If so, then the loop continues. If not, then the loop ends.

If the loop counter is still less than the total number of arguments, the simulator looks to see if the argument that corresponds to the number of the loop counter A is a Boolean or object value 135. If the argument is Boolean or object, then the argument is assigned the range of negative infinity to zero (0) and one (1) to infinity 140, and the A value increments 150. If the argument is not an object or Boolean, then that argument is assigned a range of negative infinity to infinity 145 and the A counter increments 150. Once the a counter reaches a point where it is no longer less than the number of arguments, the loop ends 130.

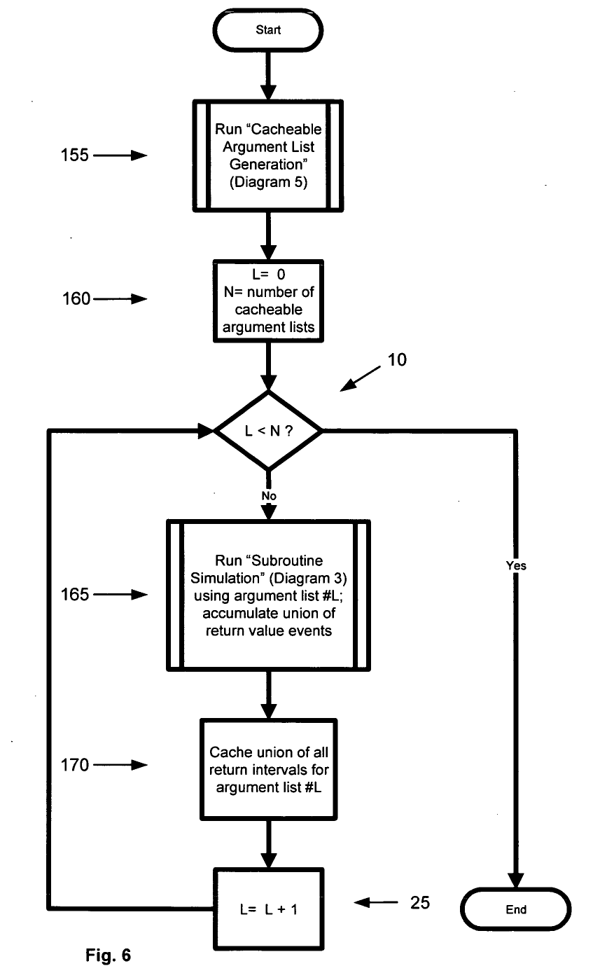

FIG. 6 is used to generate a listing of outputs that correspond to the input intervals used in the simulation. Each time the simulation is performed, a new list needs to be dynamically created. The inputs need to be examined to see what values of input ranges are relevant. This requires a new argument list to be generated for each instance, as shown in FIG. 5. The first step is to generate this argument list 155.

Once the list is generated, certain variables need to be initialized. The loop counter for the algorithm is set to zero (0) and the number of arguments generate is established 160. Once the loop begins, the repetition of the loop is determined by the first argument, asking if the loop iteration number is less than the total number of arguments 10. If the number of loops is greater than or equal to the number of arguments, then the loop ends. If the iteration number is less than the total number of arguments, then the process continues 10.

Once the loop begins, the values of the intervals must be generated. The argument list previously generated per FIG. 5 is accessed. This narrows down the list of possible ranges from any range to those that have been precompiled. This increases the speed of the processing by using the list of outputs for the subroutine inputs. The argument that corresponds to the loop counter number is then sent to be processed through the subroutine simulation algorithm 165.

The return values for all values are cached as a union of all return intervals. If the union is zero (0), then the routine never completes, causing an exception. This can lead to knowledge of a possible null pointer in the subroutine. After the return values are unioned, the loop counter increments and is sent back to the beginning of the subroutine 170. The loop continues if the loop counter is still lower than the total number of arguments.

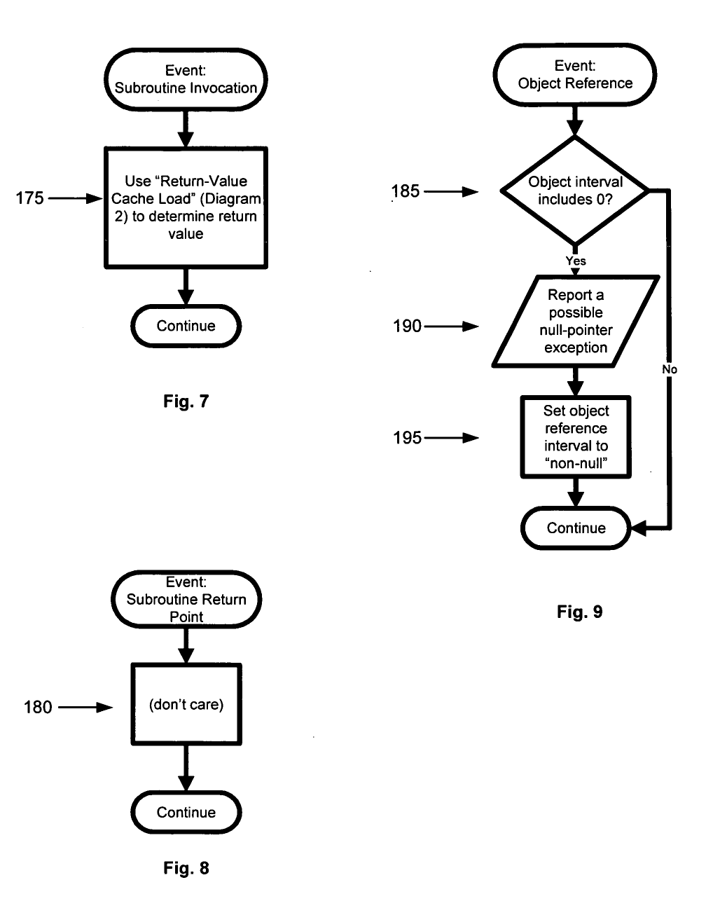

While the preceding diagrams have been for general applications, the next few diagrams show more specific uses of the method for the method's use in null pointer detection. FIG. 7 shows a subroutine being invoked. The return value cache load algorithm is used to return the results that could be null pointers 175. FIG. 8 shows when a null point could be caused by a subroutine return point 180. This method is not as viable.

FIG. 9 shows how to determine a null pointer error via an object reference. If the object interval does not contain zero (0), then this process is skipped 185. If the interval does have a zero (0), then it will report a possible null-pointer exception 190. The object reference is set to a non-null state, and the process continues 195. The value is set to non-null in order to make the process continue while at the same time recording the error.

The preceding invention is a method, system, and program for static analysis of source code by simulation of source code execution. The invention performs a simulation of subroutine source code execution while tracking the associated data values in the specific data formation of intervals during the simulation. When the data flow reaches a predetermined event, the data flow can bifurcate to simulate multiple data flow paths while also identifying these as points of interest. These points of interest are recorded during the simulation and relayed to a code analyst as a point of interest along with the results of the simulation.

Although the present invention has been described in detail herein with reference to the illustrative embodiments, it should be understood that the description is by way of example only and is not to be construed in a limiting sense. It is to be further understood, therefore, that numerous changes in the details of the embodiments of this invention and additional embodiments of this invention will be apparent to, and may be made by, persons of ordinary skill in the art having reference to this description. It is contemplated that all such changes and additional embodiments are within the spirit and true scope of this invention as claimed below.

What is claimed is:

1. A method for static analysis of source code by simulation of source code execution comprising the steps of:
performing a simulation subroutine for simulated execution of source code;
tracking data values in a specific data formation during said performance of source code simulation of said source code;
bifurcating data flow upon the occurrence of said data flow reaching a predetermined event;
identifying said predetermined event in said performance of source code simulation as an event of interest based on predetermined criteria;
notifying a simulation event receiver in the event said performance of source code simulation identifies a said event of interest relating to the execution of said source code; and
reporting from said simulation event receiver the occurrence of said event of interest.

2. A method of claim 1 where said predetermined event returns a value that causes a terminating event, said value of the event is recorded by said simulation event receiver and said value is changed to a non terminating value.

3. A method of claim 1 where values are converted into data structures called intervals which store information about the values of each variable and how the values are combined.

4. A method of claim 1 where subroutine output data flow associated with subroutine input data flow is saved in memory for use in said performance of source code analysis to allow accurate data values to be used with minimal use of computer resources.

5. A method of claim 1 where when said input data flow reaches a critical point, the input data flow is compared against previously collected input data flow and if the current input data flow values match, then the input data flow undergoes loop induction to eliminate the need to process the current input data flow and reduce the number of loops needed to perform the simulation.

6. A method of claim 1 where when said input data flow reaches a conditional jump, a sub process makes a copy of the current local variables in said input data flow to be used in a separate conditional jump performed separately.

7. A system for static analysis of source code by simulation of source code execution comprising:
a source code to be analyzed;
a computer system comprising:
an input device to receive the source code;
a set of instructions on how to simulate the execution of said source code;
a set of instructions to track data values during said performance of source code simulation;
a set of instructions to bifurcate data flow upon the occurrence of a predetermined point;
a set of instructions to identify said predetermined event in said performance of source code simulation as an event of interest based on predetermined criteria;
a set of instructions notifying a simulation event receiver in the event said performance of source code simulation identifies a point of interest has occurred;
a set of instructions for said simulation event receiver to report the incidence of said event of interest;
a memory device to record the occurrence of said event of interest; and
an output device to alert others that said event of interest has occurred.

8. A system of claim 7 where said system contains instructions for when a predetermined event returns a value that causes a terminating event, said value of the event is recorded by said simulation event receiver and said value is changed to a non terminating value.

9. A system of claim 7 where said system contains instructions for converting values into data structures called intervals which store information about the values of each variable and how the values are combined.

10. A system of claim 7 where said system contains instructions for associating subroutine output data flow with subroutine input data flow is saved in memory for use in said performance of source code analysis to allow accurate data values to be used with minimal use of computer resources.

11. A system of claim 7 where said system contains instructions for when said input data flow reaches a critical point, the input data flow is compared against previously collected input data flow and if the current input data flow values match, then the input data flow undergoes loop induction to eliminate the need to process the current input data flow and reduce the number of loops needed to perform the simulation.

12. A system of claim 7 where said system contains instructions for when daid input data flow reaches a conditional jump, a sub process makes a copy of the current local variables in said input data flow to be used in a separate conditional jump performed separately.

13. A simulator for static analysis of source code by simulation of source code execution comprising:
an input device to receive the source code;
a set of instructions on how to simulate the execution of said source code;
a set of instructions to track data values during said performance of source code simulation;
a set of instructions to bifurcate data flow upon the occurrence of a predetermined point;
a set of instructions to identify said predetermined event in said performance of source code simulation as an event of interest based on predetermined criteria;
a set of instructions notifying a simulation event receiver in the event said performance of source code simulation identifies a point of interest has occurred;
a set of instructions for said simulation event receiver to report the incidence of said event of interest;
a memory device to record the occurrence of said event of interest; and
an output device to alert others that said event of interest has occurred.

14. A simulator of claim 13 where when said predetermined event returns a value that causes a terminating event, said value of the event is recorded by said simulation event receiver and said value is changed to a non terminating value.

15. A simulator of claim 13 where values are converted into data structures called intervals which store information about the values of each variable and how the values are combined.

16. A simulator of claim 13 where subroutine output data flow associated with subroutine input data flow is saved in memory for use in said performance of source code analysis to allow accurate data values to be used with minimal use of computer resources.

17. A simulator of claim 13 where when said input data flow reaches a critical point, the input data flow is compared against previously collected input data flow and if the current input data flow values match, then the input data flow undergoes loop induction to eliminate the need to process the current input data flow and reduce the number of loops needed to perform the simulation.

18. A simulator of claim 13 where when said input data flow reaches a conditional jump, a sub process makes a copy of the current local variables in said input data flow to be used in a separate conditional jump performed separately.

19. A computer usable medium having a computer readable program code means embodied therein for static analysis of source code by simulation of source code execution, the computer usable medium comprising:
a computer readable program code means for performing a simulation subroutine for simulated execution of source code;
a computer readable program code means for tracking data values in a specific data formation during said performance of source code simulation of said source code;
a computer readable program code means for bifurcating the data flow upon the occurrence of said data flow reaching a predetermined event;
a computer readable program code means for identifying said predetermined event as an event of interest based on predetermined criteria;
a computer readable program code means for notifying a simulation event receiver in the event said performance of source code simulation identifies an event of interest relating to the execution of said source code; and
a computer readable program code means for reporting from said simulation event receiver the occurrence of said event of interest.
